(19) United States
(12) Patent Application Publication
(10) Pub. No.: US 2015/0001214 A1
(43) Pub. Date: Jan. 1, 2015

(54) HYBRID WINDING METHOD FOR THERMOPLASTIC PLASTIC-CONTINUOUS FIBER HYBRID COMPOSITE AND A HIGH PRESSURE VESSEL USING THE SAME AND A METHOD FOR MANUFACTURING THE SAME

(71) Applicant: LG Hausys, Ltd., Seoul (KR)

(72) Inventors: Gi-Hune Jung, Bucheon-si (KR); Yong-Hoon Yoon, Daejeon (KR); Hee-June Kim, Seongnam-si (KR); Tae-Hwa Lee, Gwangmyeong-si (KR); Ae-ri Oh, Anyang-si (KR)

(21) Appl. No.: 14/370,688

(22) PCT Filed: Dec. 28, 2012
(86) PCT No.: PCT/KR2012/011720

§ 371 Date: Jul. 3, 2014

(30) Foreign Application Priority Data
Jan. 11, 2012 (KR) 10-2012-0003602

(51) Int. Cl. B29C 70/20; B29C 70/68; B29C 70/22; B65D 1/40; F17C 1/16

(52) U.S. Cl. CPC B29C 70/205; B65D 1/40; F17C 1/16; B29C 70/222; B29C 70/68; F17C 2203/0604; F17C 2203/066; B29L 2031/7156
USPC 220/62.22; 156/175; 156/172

(57) ABSTRACT

A hybrid winding method for thermoplastic plastic-continuous fiber hybrid composite and a high pressure vessel using the same and a method for manufacturing the same is presented

A hybrid winding method for thermoplastic plastic-continuous fiber hybrid composite in accordance with the present invention comprises mixing and supplying a thermoplastic plastic-carbon continuous fiber hybrid composite and a thermoplastic plastic-glass continuous fiber hybrid composite; applying tension to hybrid supplied hybrid composites; winding hybrid supplied hybrid composites along an outer circumference surface of a mandrel; and applying heat to hybrid wound hybrid composites

### TECHNICAL FIELD

The present invention relates to a winding of composite materials, and more particularly, a hybrid winding method for thermoplastic plastic-continuous fiber hybrid composite and a high pressure vessel using the same and a method for manufacturing the same.

### BACKGROUND ART

Since fiber reinforced plastic (FRP), which is getting the spotlight as a new material, shows excellent mechanical properties such as specific stiffness and specific strength compared to normal metallic materials, uses in various industry fields where structural weight reduction is required are widely expanding.

This FRP is composed of fiber reinforced materials and resin matrix materials, and forming methods are differed according to structural shapes that are required. To manufacture axially symmetrical or rotating body composite material structures, from various aspects such as manufacturing costs, time, mass production, etc., filament winding methods using high specific stiffness and specific strength such as glass fibers, carbon fibers, etc. are most appropriate.

Generally, processes using FRP are most widely used in fields such as large pipes, robot hands used in manufacturing processes of liquid crystal display (LCD) or plasma display panel (PDP), high pressure vessels, etc.

Among these, FRP high pressure vessels are manufactured from following manufacturing methods. First, after fibers (filaments) such as carbon fiber are impregnated in liquefied thermoset resin such as epoxy or unsaturated polyester, carbon fiber impregnated in resin is wound on a rotating cylindrical liner (a mandrel if there is no liner). And then, after glass fiber is impregnated in liquefied thermoset resin such as epoxy or unsaturated polyester, glass fiber impregnated in resin is wound on wound carbon fiber. And then, after resin is cured by being attached to a rotating axis of a curing furnace and being rotated, a final FRP high pressure vessel is completed after going through demolding and cutting.

But, in the case of a FRP high pressure vessel manufactured by the described method, it inherits problems of bringing about increase in manufacturing costs and decrease in productivity from using a thermoset resin that requires a separate curing process as a matrix material.

For related publications, there is Korea laid-open patent No. KR 2008-0113212 (made public on 2008 Dec. 19), and in the publication, only about a pressure vessel that is coated by winding, embedded in thermoset resin, and a first reinforcement material comprising glass fibers and a second reinforcement material comprising carbon fibers is presented, and there is no mention about hybrid winding methods.

### DISCLOSURE

### Technical Problem

An objective of the present invention is to provide a hybrid (or mixed) winding method of hybrid composites containing carbon fibers and hybrid composites containing glass fibers that may have balance between economic feasibility and desired properties.

Another objective of the present invention is to provide a high pressure vessel that may have balance between economic feasibility and desired properties by using a hybrid winding method for thermoplastic plastic-continuous fiber hybrid composites containing carbon fibers and glass fibers.

Also, another objective of the present invention is to provide a method for manufacturing a high pressure vessel that may have balance between economic feasibility and desired properties

### Technical Solution

A hybrid winding method for thermoplastic plastic-continuous fiber hybrid composite in accordance with the present invention to achieve one of the described objective comprises hybrid supplying a thermoplastic plastic-carbon continuous fiber hybrid composite and a thermoplastic plastic-glass continuous fiber hybrid composite; applying tension to the hybrid composite that are hybrid supplied; winding a hybrid composite that are applied with tension after being hybrid supplied along an outer circumference surface of a mandrel; and applying heat to the hybrid composite that are hybrid wound.

Also, a high pressure vessel in accordance with the present invention to achieve another described objective comprises a liner having a shape complying to a desired vessel; and a strength reinforcing layer formed by winding a thermoplastic composite, in which a carbon continuous fiber and a glass continuous fiber is impregnated with a thermoplastic plastic, on an outer circumference surface of the liner.

Also, a method for manufacturing a high pressure vessel in accordance with the present invention to achieve another described objective comprises inserting a liner having a shape complying to a desired vessel shape; hybrid winding a thermoplastic plastic-carbon continuous fiber hybrid composite and a thermoplastic plastic-glass continuous fiber hybrid composite along an outer circumference surface of the liner while rotating the mandrel; and applying heat to the hybrid wound hybrid composites that are hybrid wound, where the step of hybrid winding the hybrid composite comprises hybrid supplying a thermoplastic plastic-carbon continuous fiber hybrid composite and a thermoplastic plastic-glass continuous fiber hybrid composite and applying tension to the hybrid composites that are hybrid supplied.

### Advantageous Effects

A winding method in accordance with the present invention, by mixing carbon fibers and glass fibers, and using a thermoplastic plastic requiring no curing process, along with reducing manufacturing costs and improving productivity, may have balance between economic feasibility and desired properties.

Also, a high pressure vessel in accordance with the present invention, by being formed by hybrid winding a hybrid composite containing carbon fibers and a hybrid composite containing glass fibers, may have balance between economic feasibility and desired properties, and recycling is possible by using thermoplastic resin.

Also, a manufacturing method for a high pressure vessel in accordance with the present invention, through a hybrid winding method using thermoplastic resin requiring no curing process, may easily balance between economic feasibility and desired properties, and manufacture high pressure vessels that improves productivity and is able to be recycled.

### DESCRIPTION OF DRAWINGS

FIG. 1 is a drawing illustrating an outline of a method for manufacturing a thermoplastic plastic-continuous fiber hybrid composite in accordance with the present invention.

FIG. 2 is a flow chart for describing a method for manufacturing a thermoplastic plastic-continuous fiber hybrid composite in accordance with the present invention.

FIG. 3 is a drawing illustrating an outline of a winding device in accordance with a preferred embodiment of the present invention.

FIG. 4 is a flow chart for describing a process for a thermoplastic plastic-continuous fiber hybrid composite in accordance with the present invention.

FIG. 5 is a perspective view illustrating a high pressure vessel in accordance with an embodiment of the present invention.

FIG. 6 is a cross sectional drawing cutting FIG. 5 in accordance with a first embodiment of the present invention along line I-I′.

FIG. 7 is cross sectional drawing cutting FIG. 5 in accordance with a second embodiment of the present invention along line I-I′.

### BEST MODE

Advantages and features of the present invention, and method for achieving thereof will be apparent with reference to the following examples. But, it should be understood that the present invention is not limited to the following examples and may be embodied in different ways, and that the examples are given to provide complete disclosure of the invention and to provide thorough understanding of the invention to those skilled in the art, and the scope of the invention is limited only by the accompanying claims and equivalents thereof. Like components will be denoted by like reference numerals throughout the specification.

Hereinafter, a hybrid winding method for thermoplastic plastic-continuous fiber hybrid composite and a high pressure vessel using the same and a method for manufacturing the same in accordance with the present invention will be described in reference to accompanying drawings.

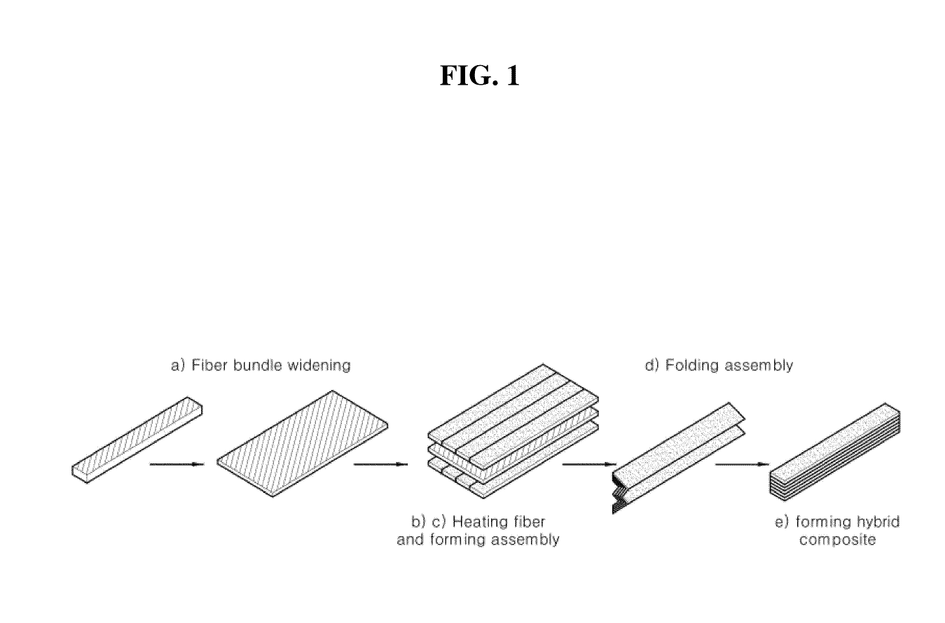

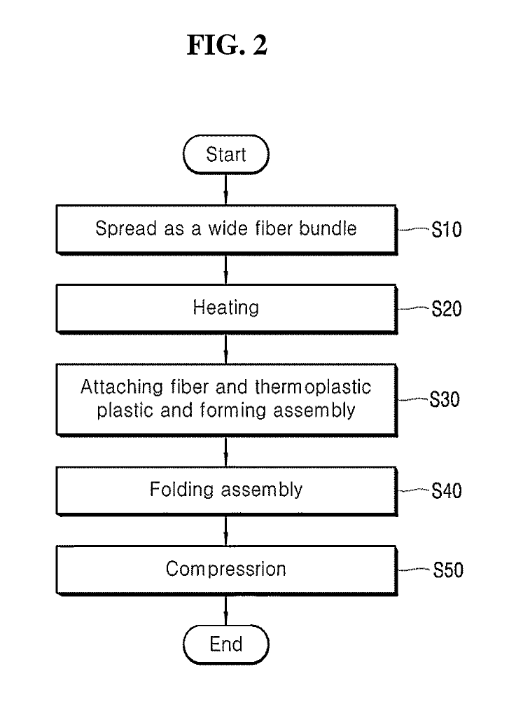

FIG. 1 is a drawing illustrating an outline of a method for manufacturing a thermoplastic plastic-continuous fiber hybrid composite in accordance with the present invention, and FIG. 2 is a flow chart for describing a method for manufacturing a thermoplastic plastic-continuous fiber hybrid composite in accordance with the present invention.

Referring to FIG. 1 and FIG. 2, a thermoplastic plastic-continuous fiber hybrid composite in accordance with the present invention has a multi-layer structure with thermoplastic plastics and fibers such as glass fibers or carbon fibers (or graphite fibers) being laminated. In this instance, thermoplastic plastic is called thermoplastic resin, and for example, it may be formed with one or more materials selected from polyamide (PA), polypropylene, polyethylene, polyethyleneterephthalate (PET), polyacetate, acrylonitril-butadiene-styrene (ABS) resin. It is preferable for a thermoplastic plastic to be formed with one or more materials from polyamide (PA), polypropylene, and polyethylene that has excellent impregnation properties, cost, physical properties, etc.

This thermoplastic plastic-continuous fiber hybrid composite may be manufactured by comprising a) spreading a glass fiber bundle and a carbon fiber bundle wide and uniformly (S10), b) applying heat to a spread glass fiber or carbon fiber (S20), c) forming a thermoplastic plastic-continuous fiber assembly by bonding a heated glass fiber or carbon fiber and a thermoplastic plastic in a tape form (S30), d) making a multi-layer thermoplastic plastic-continuous fiber assembly by folding an assembly in a zigzag shape (S40), compressing a multi-layer thermoplastic plastic-continuous fiber assembly (S50).

For glass fiber bundles in step (a), it is not specially limited if it is used for common continuous fiber strengthened plastics, but it is preferable to select a glass fiber that is sizing treated to increase chemical bonding strength. Also, it is better for a diameter of a glass fiber to be smaller, but it is commonly preferable to be at a level of 15 μm to 20 μm.

For conventional glass fiber bundles, 1200TEX is preferable in aspects of widening than 2400TEX, but using 2400TEX is more preferable since productivity is high when considering economic aspects. For carbon fiber bundles, 24K, which is commonly used in winding process, may be used. It is better for a diameter of a carbon fiber to be smaller, but it is commonly preferable to be at a level of 2 μm to 7 μm.

In step a), a glass fiber bundle or a carbon fiber bundle may be uniformly spread by steadily widening it by using a multi-step convex bar and a guide bar.

In applying heat in step b), a glass fiber bundle or a carbon fiber bundle is heated to a temperature of 120 to 280° C. When bonding a glass fiber bundle or a carbon fiber bundle to a thermoplastic plastic in a tape form in this temperature range, flexibility of the manufactured thermoplastic plastic-continuous fiber hybrid composite is excellent and thus having effects of ease of weaving. Temperature in this instance is appropriately selected by referring to melting temperatures in accordance with types of thermoplastic plastics in a tape form used, and it is preferable to be optimized to a temperature as high as possible for a hybrid composite to maintain flexibility.

Thermoplastic plastic in a tape form of step c) may be multiple plastic tapes having constant widths spread and arranged without gap on a same surface, and it is preferable for the sum of widths to be same as the width of a heated glass fiber or carbon fiber. Thermoplastic plastic in a tape form of step c) may be located on top or on top and bottom of the heated glass fiber or carbon fiber, but it is preferable to be located on both sides of top and bottom.

Width of a thermoplastic plastic tape is not specifically limited, but may be width of 5 mm to 40 mm, preferably width of 10 mm to 20 mm, and amount of fibers in a manufactured thermoplastic plastic-continuous fiber hybrid composite may be adjusted by adjusting this.

When width of a thermoplastic plastic tape is less than 5 mm, adjusting amount of fibers in a hybrid composite is difficult, and when exceeding 40 mm, there are difficulties in applying a winding process in products having a curved dome shape such as a high pressure vessel.

It is preferable for thermoplastic plastic-continuous fiber hybrid composite comprising glass fibers to be adjusted to comprise glass fiber in an amount of 40 weight % to 80 weight %. When an amount of glass fiber is less than 40 weight %, shock resistance of a hybrid composite may be degraded. On the contrary, when an amount of glass fiber exceeds 80weight %, specific stiffness of a hybrid composite may be degraded.

It is preferable for a thermoplastic plastic-continuous fiber hybrid composite comprising carbon fiber to be adjusted to comprise carbon fiber in an amount of 40 weight % to 80 weight %. When an amount of carbon fiber is less than 40 weight %, specific stiffness of a hybrid composite may be degraded. On the contrary, when an amount of carbon fiber exceeds 80 weight %, along with degradation in shock resistance, may bring about increase in manufacturing costs. This is because price level of a carbon fiber of 24K is 30,000 won per kg, and is about 20 times the price compared to 2400TEX glass fiber, which has a price level of 1,500 won per kg. But, when comparing tensile strength based on isotropic composites weaved by continuous fibers, tensile strength of carbon fibers is only about two times than that of glass fibers.

Arithmetical calculation considering specific gravity is as follows. First, when using 100% of glass fiber, weight becomes about 3.0 times compared to carbon fiber composites, but price level becomes about 15%. When using 50% of carbon fiber, weight becomes about 2.0 times compared to glass fiber composites, but price level becomes about 57%. When using 75% of carbon fiber, weight becomes about 1.5 times compared to glass fiber composites, but price level becomes about 79%.

For this reason, when light weight is not absolutely required, it is preferable to use as a hybrid of carbon fibers and glass fibers considering economic feasibility, and balance between economic feasibility and required physical properties may be achieved through adjusting amount of these.

A thermoplastic plastic-continuous fiber assembly of step c) may be a laminated structure of glass fibers or carbon fibers and thermoplastic plastics in a tape form, or a structure with thermoplastic plastic tape, glass fiber or carbon fiber and thermoplastic plastic in a tape form laminated in sequence. A structure with thermoplastic plastic tape, glass fiber or carbon fiber and thermoplastic plastic in a tape form laminated in sequence is preferable.

Since elongation characteristics are not required for thermoplastic plastics in a tape form, most of commercialized thermoplastic plastics that may be processed in a film or a tape form may be applied. Thickness of thermoplastic plastics may be 30 μm to 200 μm, and may comprise a coupling agent.

A multi-layer thermoplastic plastic-continuous fiber assembly in step d) has a zigzag shape from contact surfaces of multiple plastics in a tape form being folded, and as a result, its width becomes same or similar to a width of one plastic tape.

Compression of step e) may be carried out under condition of 120° C. to 280° C. When compression temperature is less than 120° C., folded state of a multi-layer thermoplastic plastic-continuous fiber assembly may not be maintained and become unfolded, and when exceeding 280° C., flexibility of hybrid composites may be lost due to excessive impregnation.

A thermoplastic plastic-continuous fiber hybrid composite manufactured from steps a) to e) is a composite using carbon fibers or glass fibers as continuous fibers, and using thermoplastic plastics for matrix materials, and means a continuous fiber strengthened plastic before melting impregnation of plastic resin from heat compression.

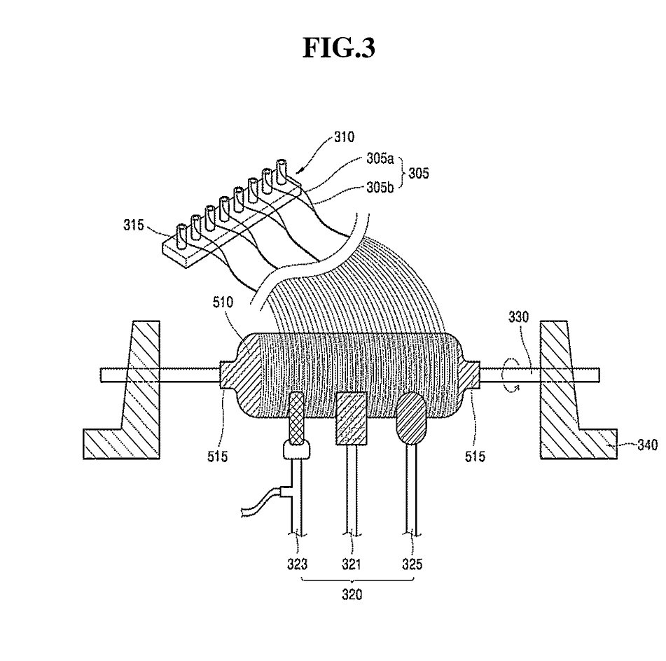

Hereinafter, a hybrid winding method using thermoplastic plastic-continuous fiber hybrid composites manufactured by FIG. 1 is described referring to FIG. 3 to FIG. 7, and a high pressure vessel using the same and a method for manufacturing the same is described.

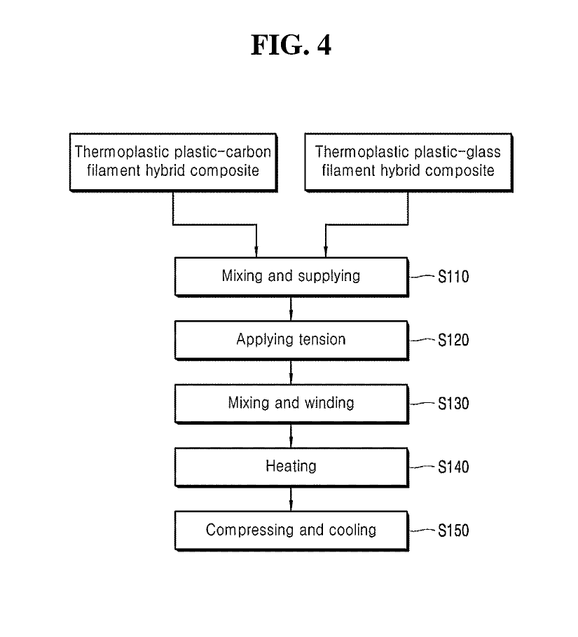

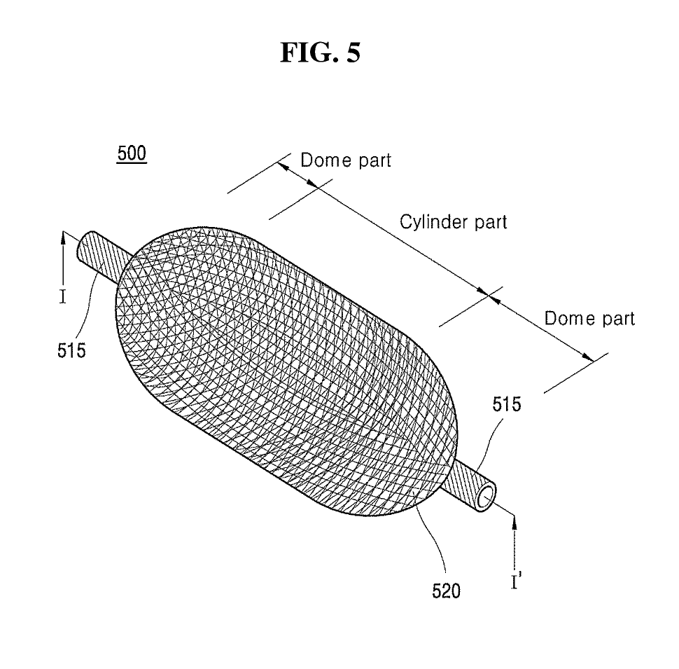

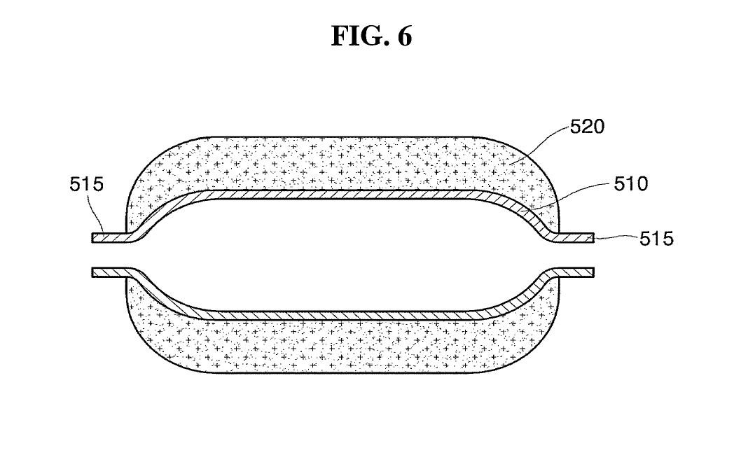

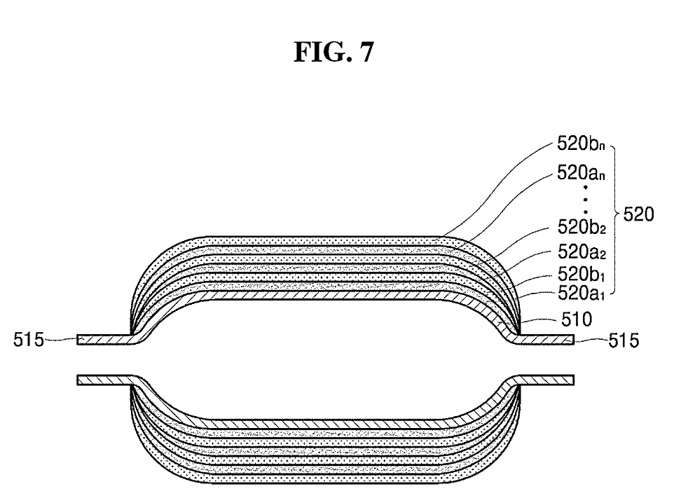

FIG. 3 is a drawing illustrating an outline of a winding device in accordance with a preferred embodiment of the present invention, FIG. 4 is a flow chart for describing a process for a thermoplastic plastic-continuous fiber hybrid composite in accordance with the present invention, FIG. 5 is a perspective view illustrating a high pressure vessel in accordance with an embodiment of the present invention, FIG. 6 is a cross sectional drawing cutting FIG. 5 in accordance with first embodiment of the present invention along line I-I′, and FIG. 7 is cross sectional drawing cutting FIG. 5 in accordance with second embodiment of the present invention along line I-I′.

Referring to FIG. 3, a winding device is composed by comprising a fiber supply member (310), a winding head (320), and a mandrel (330).

A fiber supplying member (310) is a common member supplying a thermoplastic plastic-continuous fiber hybrid composite (305) containing glass fibers or carbon fibers, and comprises a thermoplastic plastic-continuous fiber hybrid composite (305) wound on multiple bobbins (315) having a reel shape.

One of the thermoplastic plastic-continuous fiber hybrid composite (305) may be a thermoplastic plastic-carbon continuous fiber hybrid composite (305a), and the other may be a thermoplastic plastic-glass continuous fiber hybrid composite (305b), and these two hybrid composites (305a, 305b) may be arranged neighbouring each other. Here, a thermoplastic plastic-continuous fiber hybrid composite (305) may exist in a roving state, and during winding, these two hybrid composites (305a, 305b) may be supplied as a carbon fiber-glass fiber hybrid roving in a hybrid (or a mixed) state.

A mandrel (330) is for winding a thermoplastic plastic-continuous fiber hybrid composite (305) supplied from a fiber supplying member (310) by a rotational actuation, and may be a basic frame for a forming material. A mandrel (330) is fastened to a support fixture (340), and is able to rotate at a constant speed in a horizontally supported state.

Meanwhile, in FIG. 3, a state in which a liner (510) is inserted in a mandrel (330) is illustrated. A liner becomes a basic frame for a high pressure vessel (500, refer to FIG. 5) in accordance with the present invention, and is inserted in a mandrel and may rotate at a constant speed. A liner (510) is responsible for sealing and corrosion resistance of a high pressure vessel (500), and may be formed with a metallic material such as steel, aluminium (Al) and in a cylindrical shape having a containing space inside.

A liner (510) may have a shape complying to a vessel shape, and more preferably may actually have an identical shape, for example, as illustrated in FIG. 5, may be a shape comprising a cylinder part of a cylinder shape located at a middle part and a dome part of a dome shape at both edges. In a central part of end of a dome part, a boss (515), which is extended and protruded from a dome part, of a metal material may be provided to provide a jointing system with an exterior auxiliary. Different from the drawing, a boss (515) may be formed only at an end of one side.

A winding head (320) may be composed of a tension part (321) applying tension to a carbon fiber-glass fiber hybrid roving, a torch part (323) applying heat to a carbon fiber-glass fiber hybrid roving, and a roll part (325) compressing and cooling a carbon fiber-glass fiber hybrid roving.

A tension part (321), a torch part (323), and a roll part (325) are placed separated from each other, and a roll part (325) may be left out. A winding head (32) is able to rotate 9 or more axes by a rotating motor (not illustrated) and a transferring device (not illustrated).

A winding device may apply a single head or multi heads. In the case of a multi head winding device, a torch part (323) may adopt a method of applying heat using a combustion gas method to downsize the size of a winding head (320). In the case of a single winding device, a method using electrical heating devices or a method using lasers, etc. other than a method using combustion gas may be adopted, but methods using electrical heating devices or lasers have disadvantages of enlargement of head sizes.

In the case of a torch part (323) using a combustion gas method, flow rate of combustion gas is controlled in accordance with linear velocity of winding of a carbon fiber-glass fiber hybrid roving.

Meanwhile, not illustrated, a winding device may further comprise a fiber transfer device between a fiber supply member (310) and a mandrel (330) to guide a thermoplastic plastic-continuous fiber hybrid composite (305) supplied from a fiber supplying member (310) to a mandrel (330). A fiber transfer device may be installed on a protrusion part where a protrusion is formed and located facing a fiber supplying member (310). A driving method for this winding device is examined below. First, a mandrel driving device (not illustrated) is driven to mix and supply a thermoplastic plastic-carbon continuous fiber hybrid composite (305a) and a thermoplastic plastic-glass continuous fiber hybrid composite (305b) from a fiber supplying member (310) while rotating a mandrel (330) (S110). Then, tension is applied to each carbon fiber-glass fiber hybrid roving, in which these two hybrid composites (305a, 305b) are mixed, by a tension part (321) (S120), and then, a carbon fiber-glass fiber hybrid roving is continuously wound at a constant speed along an outer surface of a rotating liner (510) (a mandrel (330) in the case of not having a liner (510)) (S130).

This hybrid winding process uses a winding head (320) able to be rotated in 9 or more axes, and moved freely in a desired direction such as X-axis direction, Y-axis direction, Z-axis direction, etc. with respect to a mandrel (330), and may continuously wind a carbon fiber-glass fiber hybrid roving on a liner as illustrated in FIG. 5. Here, X-axis winding is a longitudinal winding (or helical winding) winding in a winding angle almost matching a rotating direction of a liner (510), and Y-axis direction winding is a hoop winding constantly winding in a winding angle almost perpendicular to an axis. During winding process, winding angle may be adjusted in accordance with a rotating speed of a liner (510) (a mandrel (330) in the case of not having a liner (510)) and a rotational or transfer speed ratio of a winding head (320). Meanwhile, even though not illustrated, boss (515) is also wound by a carbon fiber-glass fiber hybrid roving.

A carbon fiber-glass fiber hybrid roving wound on a liner (510) (a mandrel (330) in the case of not having a liner (510)), after heat is applied through a torch part (323) (S140), is compressed and cooled by a roll part (325) (S150). Through this heat press process, thermoplastic plastic is melt impregnated into the carbon fiber-glass fiber hybrid roving. This is because a carbon fiber-glass fiber hybrid roving is a unique material having a structure that may sufficiently impregnate even with an appropriate heat and pressure.

Meanwhile, a thermoplastic plastic may be melt impregnated into a carbon fiber-glass fiber hybrid roving, without question, even when omitting a compression process by a roll part (325).

And then, after separating a liner (510) (a wound structure in the case of not having a liner (510)) through conventional methods such as cooling a mandrel (330), etc., and after going through a cutting process, a high pressure vessel (500) of the present invention illustrated in FIG. 5 is completed.

Since a hybrid winding process of the present invention uses a thermoplastic plastic as a matrix material, contrary to a thermosetting resin, a curing process is not required.

Especially, when carbon fiber-glass fiber hybrid roving is wound along an outer surface of a liner (510), carbon fiber-glass fiber hybrid roving may be hybrid in a vertical configuration or a horizontal configuration and may be continuously wound.

From these, in the case where a hybrid widing configuration is a vertical configuration, two hybrid composites (305a, 305b) are wound by arranging alternately neighbouring each other on a same surface. Due to this, when a thermoplastic plastic is melt impregnated into a carbon fiber-glass fiber hybrid roving by a heat press (or heat), as the interface of these two hybrid composites (305a, 305b) mixes with each other, as illustrated in FIG. 6, a high pressure vessel (500) with a single layer strength reinforcing layer (520) formed by a thermoplastic composite, in which carbon fiber and glass fiber are impregnated in thermoplastic plastic, wound on an outer surface of a liner (510) is formed.

Whereas, in the case where a hybrid widing configuration is a horizontal configuration, two hybrid composites (305a, 305b) are wound by stacking numerous layers alternately on the different surfaces with each other. In this instance, one of thermoplastic plastic-carbon continuous fiber hybrid composites (305a) is in contact with a liner (510), and one of thermoplastic plastic-glass continuous fiber hybrid composites (305b) is exposed exteriorly. As a result, interface between these two hybrid composites (305a, 305b)is maintained even after thermoplastic plastic is melt impregnated into carbon fiber-glass fiber hybrid roving by a heat press (or heat). And thus, as illustrated in FIG. 7, a high pressure vessel (500) is formed with multiple strength reinforcing layers (520) of first to nth layer (520a₁, 520b₁, 520a₂, 520b₂, . . . , 520aₙ, 520bₙ), where a first strength reinforcing layer (520a) formed by a thermoplastic composite of a carbon fiber impregnated in athermoplastic plastic, wound on an outer surface of the liner (510), and a second reinforcing layer (520b) formed by a thermoplastic composite of the glass fiber impregnated in thermoplastic plastic, wound on an outer surface of the liner (510), are alternately laminated. In this instance, one layer of a first strength reinforcing layer (520a) is in contact with a liner (510), and one layer of a second reinforcing layer (520b) is exposed in an exterior.

Since this high pressure vessel (500) is formed by comprising a strength reinforcing layer (520), which is formed by a thermoplastic composite, in which carbon fiber and glass fiber are impregnated in thermoplastic plastic, hybrid wound on the outer surface of a liner (510), balancing between economic feasibility and required physical properties from user requests are easily accomplished, and recycling is possible from using thermoplastic resin. But the case of a hybrid winding configuration in a vertical configuration is more favourable in aspects of uniformity and adjusting amount of carbon fiber and glass fiber.

Meanwhile, in the case of pipes or robot hands where there is no limitation in width of roving, a hybrid winding method mixing vertical configuration and horizontal configuration may be used.

As such, a winding method of the present invention, by using carbon fiber and glass fiber mixed, economic feasibility and required physical properties may be balanced through adjusting amount of carbon fiber and glass fiber when manufacturing a formed article not requiring lightweight that much.

Also, by using a thermoplastic plastic requiring no curing process as a matrix material, there are effects of reduction in manufacturing costs and improvements in productivity. Also, when applying the described hybrid winding method for manufacturing a high pressure vessel, economic feasibility and required physical properties may be easily balanced, and along with reduction in manufacturing costs and improvements in productivity, manufacturing high pressure vessel able to be recycled is possible.

Meanwhile, for convenience of description of the present invention, a hybrid winding method for thermoplastic plastic-continuous fiber hybrid composite of the present invention is described using forming of a high pressure vessel, but it is not limited to this, and, of course, may be applied for manufacturing various formed substrates such as pipes, robot hands, etc.

Hereinafter, examples of the present invention is compared and presented.

### EXAMPLE

After adhering 50 weight % of PA66 tape and 50 weight % of carbon fiber, which is heated to a temperature of260° C. after widened, it is folded in a zigzag shape, and then compressed using a roller, and an isotropic composite woven from continuous fibers was manufactured.

### Comparative Example

Except for using glass fiber instead of carbon fiber, it is identical to the example.

Physical Properties Measurement Test

<Tensile Strength>

Tested based on ASTM D638. But, size of specimens is according to Type1, and tensile speed is 5 mm/min.

TABLE 1

| Classification | Example | Comparative example |
|---|---|---|
| Tensile | 53 GPa | 23 Gpa |
| Strength | | |

Table 1 is a measurement result of a tensile strength of a continuous fiber isotropic composite from example and comparative example.

Referring to Table 1, when using 50 weight % of carbon fiber, tensile strength of carbon fiber of about 2.3 times than tensile strength of glass fiber was identified.

From this, when light weight is not absolutely required, mixing glass fiber, which has a comparatively much lower price, with carbon fiber is preferable to balance between economic feasibility and required physical properties was identified.

Although described mainly by examples of the present invention, various variations and alterations can be made by those skilled in the art. These variations and alterations is within the scope of the present invention as long as it is not outside the scope of the technological concepts provided by the present invention. Therefore, the scope of the present invention should be defined by the appended claims and equivalents thereof.

[Description of Symbols]
305: thermoplastic plastic-continuous fiber hybrid composite
305a: thermoplastic plastic-carbon continuous fiber hybrid composite
305b: thermoplastic plastic-glass continuous fiber hybrid composite
310: fiber supplying member
315: bobbin
320: winding head
321: tension part
323: torch part
325: roll part
330: mandrel
340: support
500: high pressure vessel
510: liner
515: boss
520: strength reinforcing layer
520a: first strength reinforcing layer
520b: second strength reinforcing layer

1. A hybrid winding method for thermoplastic plastic-continuous fiber hybrid composite comprising,
hybrid supplying a thermoplastic plastic-carbon continuous fiber hybrid composite and a thermoplastic plastic-glass continuous fiber hybrid composite;
applying tension to the hybrid composites that are hybrid supplied;
winding the hybrid composites that are applied with tension after being hybrid supplied along an outer circumference surface of a mandrel; and
applying heat to the hybrid composites that are hybrid wound.

2. The hybrid winding method for thermoplastic plastic-continuous fiber hybrid composite according to claim 1, wherein the amount of carbon continuous fiber in the thermoplastic plastic-carbon continuous fiber hybrid composite is 40 to 80 weight %.

3. The hybrid winding method for thermoplastic plastic-continuous fiber hybrid composite according to claim 1, wherein the amount of glass continuous fiber in the thermoplastic plastic-glass continuous fiber hybrid composite is 40 to 80 weight %.

4. The hybrid winding method for thermoplastic plastic-continuous fiber hybrid composite according to claim 1, wherein winding is vertical configuration the hybrid composites that are hybrid supplied, being alternately arranged on a same surface.

5. The hybrid winding method for thermoplastic plastic-continuous fiber hybrid composite according to claim 1, wherein winding is horizontal configuration the hybrid composites that are hybrid supplied, being laminated alternately on different surfaces.

6. The hybrid winding method for thermoplastic plastic-continuous fiber hybrid composite according to claim 1, wherein winding is carried out by using a winding head being able to rotate in 9 or more axes.

7. The hybrid winding method for thermoplastic plastic-continuous fiber hybrid composite according to claim 1, further comprising compressing and cooling the wound hybrid composites after applying the heat.

8. A high pressure vessel comprising,
a liner having a shape complying to a desired vessel shape; and
a strength reinforcing layer formed by winding a thermoplastic composite, in which a carbon continuous fiber and a glass continuous fiber is impregnated with a thermoplastic plastic, on an outer circumference surface of the liner.

9. The high pressure vessel according to claim 8, wherein the strength reinforcing layer is a single layer where the carbon continuous fiber and the glass continuous fiber are mixed and impregnated in the thermoplastic plastic.

10. The high pressure vessel according to claim 8, wherein the strength reinforcing layer is a multi-layer structure, in which a first strength reinforcing layer and a second strength reinforcing layer are alternately laminated, and the first strength reinforcing layer is a thermoplastic composite in which the carbon continuous fiber is impregnated in thermoplastic plastic, and the second strength reinforcing layer is a thermoplastic plastic composite, in which the glass continuous fiber is impregnated in thermoplastic plastic.

11. The high pressure vessel according to claim 10, wherein one layer of the first strength reinforcing layer is in contact with the liner, and one layer of the second strength reinforcing layer is exposed exteriorly.

12. The high pressure vessel according to claim 8, wherein the liner has a containing space, a middle part is formed in a cylinder part having a cylindrical shape, and ends are formed in a dome part having a dome shape.

13. A high pressure vessel according to claim 12, at the central part of side ends of the dome part, further comprising a boss extending and protruding from a dome part and providing a fastening system with exterior accessories.

14. A manufacturing method for a high pressure vessel comprising:
inserting a liner having a shape complying to a desired vessel shape to a mandrel;
hybrid winding a thermoplastic plastic-carbon continuous fiber hybrid composite and a thermoplastic plastic-glass continuous fiber hybrid composite along an outer circumference surface of the liner while rotating the mandrel; and
applying heat to the hybrid wound hybrid composites that are hybrid wound,
where the step of hybrid winding the hybrid composite comprises hybrid supplying a thermoplastic plastic-carbon continuous fiber hybrid composite and a thermoplastic plastic-glass continuous fiber hybrid composite and applying tension to the hybrid composites that are hybrid supplied.

15. The manufacturing method for a high pressure vessel according to claim 14, further comprising compressing and cooling the hybrid composites that are hybrid wound after applying heat.

16. The manufacturing method for a high pressure vessel according to claim 14, wherein winding is performed in a vertical configuration winding, in which the hybrid composites that are hybrid supplied are alternately arranged on a same surface.

17. The manufacturing method for a high pressure vessel according to claim 14, wherein the winding is carried out in a horizontal configuration winding, in which the hybrid composites that are supplied hybrid are alternately laminated on different surfaces.
